(19) United States
(12) Patent Application Publication
(10) Pub. No.: US 2014/0124984 A1
(43) Pub. Date: May 8, 2014

(54) METHOD AND DEVICE FOR PRODUCING MULTI-COLOR MOLDED SKINS

(71) Applicants: Harald Dalibor, Garbsen (DE); Walter André, Bomlitz (DE); Thomas Bojahr, Garbsen (DE); Manuel Monteiro, Laatzen (DE); Jesus Galan, Dusseldorf (DE); Thomas Frotz, Burscheid (DE); Achim Lohner, Husara Hills, MI (US)

(72) Inventors: Harald Dalibor, Garbsen (DE); Walter André, Bomlitz (DE); Thomas Bojahr, Garbsen (DE); Manuel Monteiro, Laatzen (DE); Jesus Galan, Dusseldorf (DE); Thomas Frotz, Burscheid (DE); Achim Lohner, Husara Hills, MI (US)

(73) Assignee: Johnson Controls Interiors GmbH & Co. KG

(21) Appl. No.: 13/984,020

(22) PCT Filed: Jan. 24, 2012
(86) PCT No.: PCT/EP12/51026

§ 371 Date: Dec. 11, 2013

(30) Foreign Application Priority Data
Jan. 24, 2011 (DE) 10 2011 003 075.1

(51) Int. Cl. B29C 39/12

(52) U.S. Cl. CPC B29C 39/12
USPC 264/302; 425/130

(57) ABSTRACT

A device and method for producing two- or multi-color molded skins, in particular skins for a molding or component, includes a tub, in which at least two different materials can he arranged separately from one another, and a galvanic mold forming a molding or component that can be positioned relative to one another. A separating element, which separates the materials and protrudes over the tub, is introduced and positioned in the galvanic mold. Subsequently the materials are introduced separately from each other by the separating element in at least one layer in the galvanic mold.

The invention relates to a process and to an apparatus for producing multi-colored molded skins, in particular slush skins for a molded part or component, in particular a vehicle component, for example a trim element.

There are presently various production processes for producing multi-colored molded skins, for example a spraying technology with a mask or a slush molding process with two powder vats. In what is termed the slush molding process, a first covering skin layer is cooled after it has been applied. Then, a part is removed at a defined tear-off edge, in particular by means of a laser, and then both regions are coated all-over with a further skin layer. For this purpose, powder vats having a shape matched to the color region to be applied are known. These processes are very complex and costly.

It is an object of the present invention to specify a simplified process and an improved apparatus for producing multi-colored molded skins.

With respect to the process, the object is achieved according to the invention by the features indicated in claim 1. With respect to the apparatus, the object is achieved according to the invention by the features indicated in claim 11.

The dependent claims relate to advantageous developments of the invention.

In a process for producing molded skins, in particular slush skins for a molded part or component, a vat comprising at least two different plastic materials and a galvanic mold forming a molded part are positioned relative to one another, wherein a separating element which separates the plastic materials in the vat and protrudes beyond the vat is introduced, positioned and if appropriate fixed in the galvanic mold, and then the different plastic materials are applied to the molded part in a layer from at least two sides separated from one another, and the separating element is removed from the galvanic mold.

A process of this type makes it possible to produce two-colored or multi-colored molded skins, in particular slush skins, in one production step with only one vat, in particular a powder vat with an integrated seal and separating element (also called a sword). In this case, the different plastic materials, in particular plastic powders, are separated from one another by means of the integrated separating elements (swords) in the vat and during application into the galvanic mold. In addition, a separating wall for separating the materials can be arranged in the vat. The process is suitable in particular for producing two-colored or multi-colored molded skins for color separations which cannot be seen (for example since they are covered) or color separations which become visible only in a small partial region. Compared to conventional slush molding processes, the process according to the invention is simple and inexpensive.

The apparatus for producing molded skins comprises a galvanic mold and an individual vat, in particular a material or powder vat, which can be freely positioned relative to one another, wherein the vat comprises at least one separating element for separating different materials introduced into the vat, and wherein the separating element protrudes beyond the vat and an end of the separating element protruding beyond the vat can be introduced and freely positioned in the galvanic mold.

The multi-colored molded skins which are produced, in particular thin slush skins having a skin thickness in the mm range, are used in particular for a molded part or component, in particular a vehicle component, e.g. a trim element, for example a dashboard or door breast.

Essential features of the process according to the invention and of the apparatus are the use of only one vat, in particular a material vat (such as a powder vat or powder box) with an appropriate sealing technology having an integrated separating element (sword). Here, the separating element is coated with a sealing material known from mask technology, e.g. silicone. Similarly, the vat is sealed off on the outside and inside.

In the process for producing two-colored or multi-colored molded skins, the vat, in which at least two or more different materials can be arranged separated from one another, and a galvanic mold forming a molded part or component are positioned relative to one another, wherein a separating element which separates the materials and protrudes beyond the vat is introduced and positioned in the galvanic mold, and then the materials are introduced into the galvanic mold in at least one layer separated from one another by means of the separating element.

The process makes it possible to produce molded skins from two or more colors in one or more layers in a single production process, in particular in what is termed a slush process.

In one possible embodiment, the separating element can be adjusted in at least one latitude, in particular in height. As an alternative or in addition, the vat can be adjusted in at least one latitude, in particular in height. As a result of this, the separating element, which in particular is arranged movably or fixed in the vat, can be removed at least partially or entirely from the layer of the materials after the materials have been introduced into the galvanic mold, such that the separation point resulting therefrom is closed by the materials flowing into one another. As an alternative or in addition, a further material, in particular in a different color, can be applied at said separation point, in particular said separation point can be provided with a further material by in-mold lamination.

In a further embodiment, in the positioned and/or fixed state of the vat and galvanic mold, the separating element is pressed against the inner wall of the galvanic mold with a predefined force, in particular by means of spring force. This ensures a defined separation of the materials as they are being introduced into the galvanic mold, such that two-colored or multi-colored skins are made possible for color separations which cannot be seen (for example owing to covering) or for color separations which become visible only in a small partial region.

Expediently, the separating element is removed from the galvanic mold after the materials have been introduced. As a result of this, a further different material, in particular of a different color, can be applied in the region of the separation point of at least two different materials, in particular of different colors. As an alternative or in addition, the separation point can be further treated. Thus, for example, the separation point can be sealed. In addition, at least one further layer of materials can be introduced into the galvanic mold by renewed positioning of the separating element after a first introduced layer of materials has cured.

According to one development of the invention, the galvanic mold is rotated during the introduction of the materials, as a result of which a layer of the different materials in the form of a compact molded skin of the separately deposited materials, and therefore in the case of differently colored materials a multi-colored molded skin, forms on the inner wall of the galvanic mold. In this case, the materials can preferably be deposited on the inner wall of the galvanic mold in such a manner that a multi-colored layer corresponding to the number of materials forms.

According to a further embodiment of the invention, after the materials have been deposited on the inner wall of the galvanic mold in the form of a multi-colored layer, the separating element is removed at least partially or entirely from the layer in such a manner that a defined separation point of the materials is formed. In particular, the separating element is removed in such a manner that the defined separation point has a width of at most 0.5 mm, in which the materials are mixed with one another, in particular blend or gel together.

Depending on the application, a further material can be applied in the region of the separation point of the materials. In particular, a differently colored material for identifying the separation point or a material sealing the separation point can be applied. In addition, after the material vat has been removed, powder or a liquid plastisol, in particular a pulverulent or pasty thermoplastic polymer, can be sprayed onto the separation point during or before the sintering phase, for example by means of a spraying unit, e.g. a robot. During the sintering phase, the materials then blend together.

According to one development, the galvanic mold is heated. This makes it possible for the molded skin to be optimally cured and removed from the mold. In addition, a multi-layered deposition of the materials and therefore the production of multi-layered molded skins from different, in particular differently colored, materials is possible in a simple manner.

According to a further embodiment of the invention, the separating element is cooled. As a result of this, the separating element is adequately dimensionally stable and resistant to the process heat, such that the materials are reliably separated. In addition, the separating element can be used repeatedly. On account of the contact between the separating element and the hot galvanic mold, the separating element, in particular the contacting seal, heats up with each coating cycle. In this case, during the waiting time for the next cycle, the separating element, in particular the seal, cannot adequately cool down. Upon withdrawal of the separating element, this can lead to accumulations of initially gelled material in the form of threads or agglomerates or to initially gelled material falling onto the rear side of the molded skin and therefore to thickened areas of the molded skin.

With respect to the apparatus for producing two-colored or multi-colored molded skins for a molded part or component, the object is achieved according to the invention in that a vat, in which at least two different materials can be arranged separated from one another, and a galvanic mold forming a molded part or component are provided, wherein a separating element which separates the materials is arranged in the vat, and the vat and the galvanic mold can be positioned relative to one another, and also the separating element can be introduced into the galvanic mold protruding beyond the vat in such a manner that then the materials can be introduced into the galvanic mold in at least one layer separated from one another by means of the separating element. It is preferable that the galvanic mold itself forms the molded part or component, for example a glove box, a dashboard or a similar molded part. In other words: the galvanic mold has a shape and contour corresponding to the molded part or component. Alternatively, a conventional galvanic mold can be used.

In this case, the separating element is intended to separate the different materials from one another during application and/or introduction, such that, in the case of differently colored materials, a two-colored or multi-colored molded skin is formed. Here, the materials can be introduced into the galvanic mold, in particular applied to the inner wall, by means of spraying, casting (slush process) or by means of the introduction of powder, separated by the separating element.

The separating element can be retracted or extended into the galvanic mold in particular in a manner running perpendicularly to the axis of rotation.

In one possible embodiment, the separating element is formed as a sword. In particular, that end of the separating element which protrudes into the galvanic mold is provided with a defined shape, such that the materials are reliably separated. By way of example, the end protruding into the galvanic mold has a conical shape. Alternatively, the end can have a pointed, round or rectangular shape. In this respect, the shape of the end can correspond to a shape of a separating groove arranged in the galvanic mold. Alternatively, the separating element can be formed as a separating wall.

It is also possible for a plurality of separating elements and/or separating walls to be provided, as a result of which in particular a multi-colored molded skin can be formed. By way of example, a plurality of separating elements are arranged in the vat, in particular a number of separating elements which corresponds to the number of colors of the multi-colored molded skin. In this respect, the separating elements are arranged adjustably in the vat separately from one another. Alternatively, the separating elements can also be adjustable together.

Furthermore, the separating element can be coated or provided at least partially with a sealing material or have a varying thickness. In particular, that end of the separating element which protrudes into the galvanic mold can itself be formed from a sealing material, e.g. silicone. This makes it possible to reliably press the separating element against the inner wall of the galvanic mold, such that the materials are reliably separated from one another as they are being introduced into the galvanic mold.

According to a further embodiment, the galvanic mold is provided with a separating groove, which is made in the inner wall and in which in particular the separating element can be positioned during the introduction of the materials. To this end, the separating element and the separating groove have mutually corresponding shapes and dimensions. Such an arrangement of the separating element in a separating groove makes it possible to achieve a reliable separation of the materials from one another as they are being introduced and, after removal of the separating element, defined blending of the materials during curing with a defined separation point.

The advantages achieved with the invention consist in particular in short process times and low thermal loading of the material. In addition, the process is suitable for producing multi-colored molded skins, in particular molded skins having more than two colors, e.g. three-colored molded skins, from PVC or another plastic. In this case, the molded skin produced in particular in one part and with a plurality of colors has the advantage that subsequent process steps, for example foaming with a backing part, punching, milling, etc., can be carried out without additional outlay compared to conventional multi-colored and consequently separated components.

The invention will be explained in more detail hereinbelow with reference to the attached schematic figures.

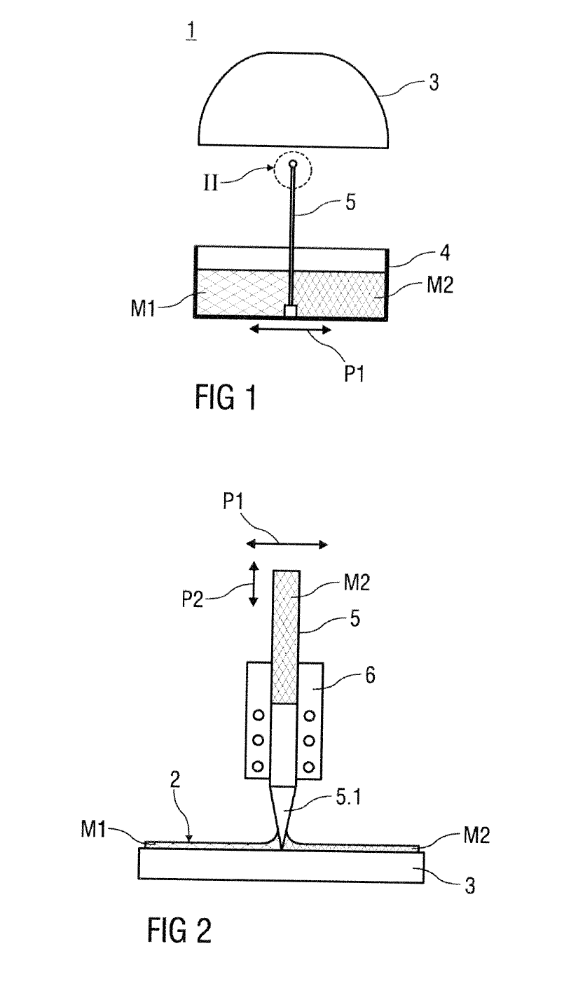

FIG. 1 schematically shows an apparatus for producing multi-colored molded skins, comprising a galvanic mold and a vat with an integrated separating element,

FIG. 2 schematically shows an end of the separating element, as shown in FIG. 1, protruding into the galvanic mold and a molded skin formed from two materials in the galvanic mold,

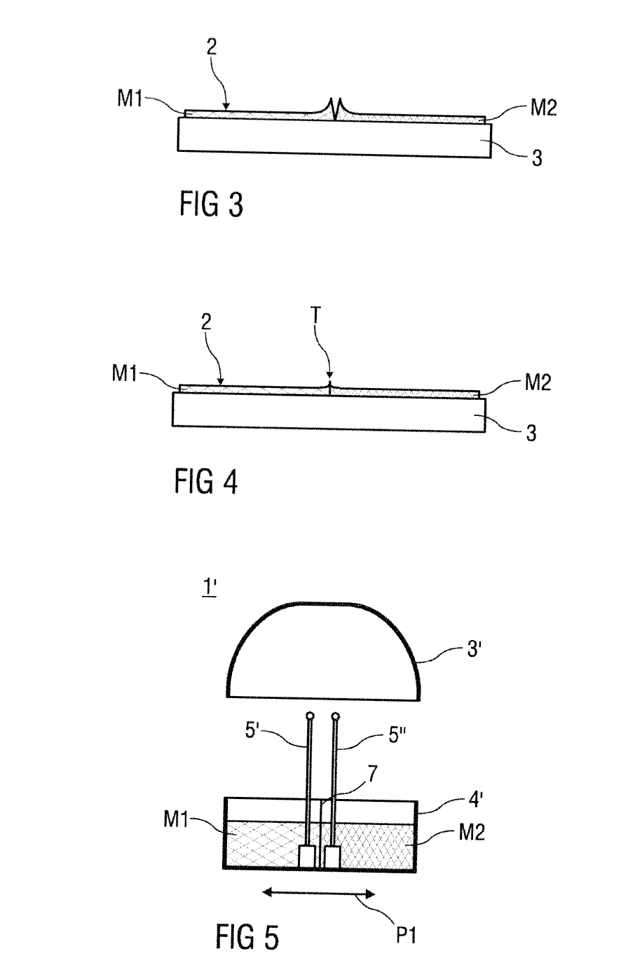

FIG. 3 schematically shows the molded skin formed as shown in FIG. 2 after

FIG. 4 schematically shows the molded skin formed as shown in FIGS. 2 and 3 after curing,

FIGS. 5 to 10 schematically show an alternative embodiment of the apparatus having two separating elements in a vat,

FIG. 11 schematically shows in detail an exemplary embodiment for a separating element,

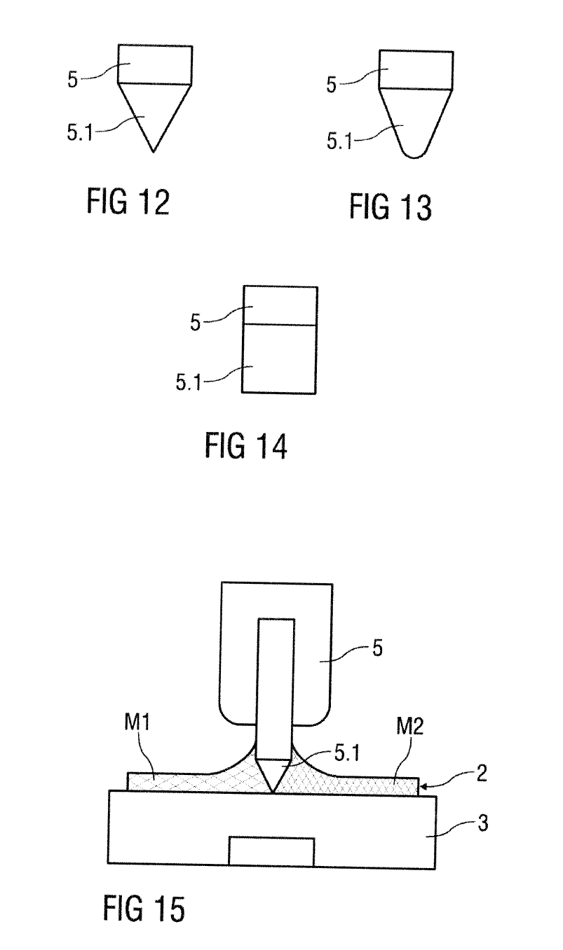

FIGS. 12 to 14 schematically show various embodiments for the end of the separating element,

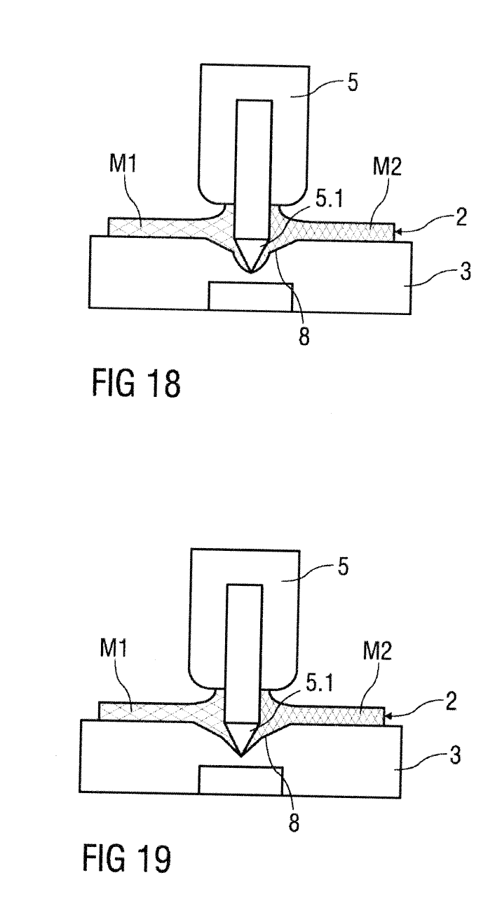

FIGS. 15 to 19 schematically show various embodiments for a separating groove integrated in the galvanic mold and the end of the separating element of the vat,

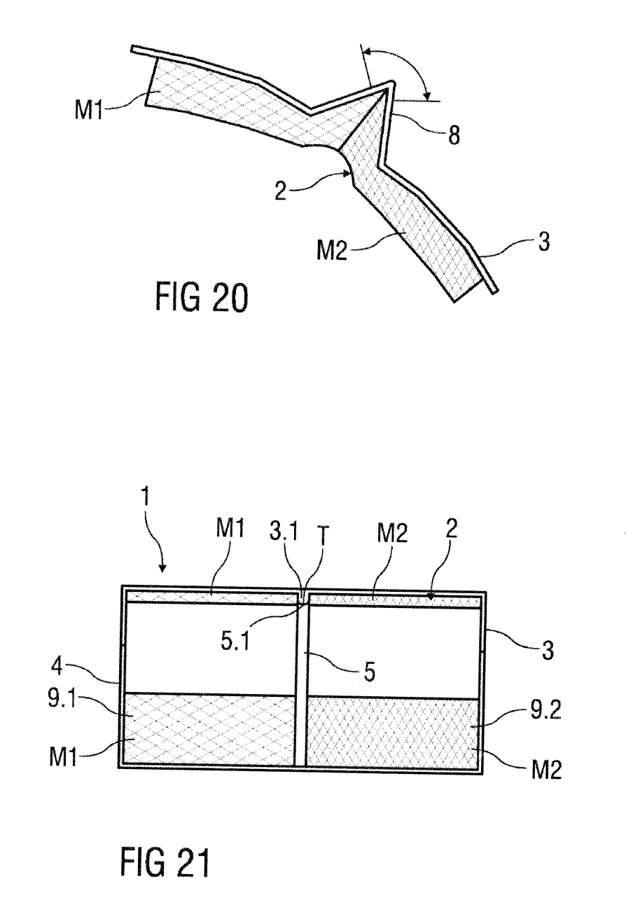

FIG. 20 schematically shows an exemplary embodiment for a position of a covered color separation for a molded skin,

FIGS. 21 to 23 schematically show an exemplary embodiment for the course of the production of a two-colored molded skin having a differently colored separation point, and

FIGS. 24 to 27 schematically show an exemplary embodiment for the course of the production of a two-colored molded skin having materials which have blended at the separation point.

Parts which correspond to one another are provided with the same reference signs in all figures.

FIG. 1 schematically shows an apparatus 1 for producing a multi-colored molded skin 2, as shown in FIG. 2. The apparatus 1 comprises a galvanic mold 3 and a vat 4 with an integrated separating element 5.

The molded skin 2 is produced in the galvanic mold 3. In this case, the shape of the galvanic mold 3 defines the shape of the outer contour of the molded skin 2 (also called slush skin). Here, at least two materials M1, M2 are introduced into the galvanic mold 3 and separated from one another by way of the separating element 5 integrated in the vat 4.

According to the invention, for receiving at least two materials M1, M2, in particular powders, e.g. polymer powders or PVC powders, the vat 4 has the separating element 5, which divides the vat 4 into chambers.

To produce a two-colored molded skin 2, the galvanic mold 3 rotates in a conventional manner, with a two-colored layer in the form of the compact molded skin 2 forming from the materials M1, M2 on a heatable inner wall of the galvanic mold 3.

FIG. 2 schematically shows an end 5.1 of the separating element 5, as shown in FIG. 1, protruding into the galvanic mold 3 and a molded skin 2 formed from two materials M1, M2 in or on the galvanic mold 3. The separating element 5 can optionally be provided with a cooling device 6.

As shown in FIG. 2, the end 5.1 (also called a sword tip) protrudes into the galvanic mold 3 in such a manner that the latter and the end 5.1 are in contact or at a small distance apart.

In this case, the separating element 5 can be arranged in the vat 4 fixedly or movably in at least one latitude. In particular, the separating element 5 can be adjustable in height or lengthwise, for example adjustable along the arrows P1, P2. In this respect, the separating element 5 is designed to be retractable or extendable along the arrow P2, such that the two materials M1, M2 are always arranged separated from one another in the vat 4 and a two-colored molded skin 2 is formed.

For a galvanic mold 3 forming, for example, a glove box, a separating wall with an adapted contour (with tolerances −1 mm) is produced transversely to the axis of rotation as a separating element 5. This separating element 5 can be positioned exactly, e.g. by way of pins and bushings. In this case, the separating element has a different thickness along the longitudinal axis. By way of example, the separating element 5 is thicker in the region of the vat 4 than in the region of the end 5.1 protruding into the galvanic mold 3. In particular, the end 5.1 has a conical form.

For exact contour adaptation in the “hot” state, the galvanic mold 3 is installed in a prototype system. The narrow side of the separating element 5 is coated with a sealing material which is known from mask technology, e.g. silicone. If the galvanic mold 3 is then heated and moved into the position of a docking station (not shown), the separating element 5, in particular the end 5.1 thereof, is manually introduced, positioned and fixed in the galvanic mold 3, such that the materials M1, M2 can be introduced into the galvanic mold 3 separated by the separating element 5 and cured.

After the curing process, the separating element 5 is removed from the galvanic mold 3. Following the conical contour, the separating element 5 is reworked in such a way that a sealing or cover line having a width of, for example, approximately 0.5 mm forms at the contact line between the separating element 5 and the galvanic mold 3.

To position the galvanic mold 3 and the vat 4 having an integrated separating element 5, provision is made of positioning and/or fixing elements, e.g. pins, bushings. Positioning aids such as pin-bushing connections (in the form of floating and locating bearings) ensure the reproducibility of the positioning.

If the galvanic mold 3 is heated again and is located in the powder station (not shown), the separating element 5 is positioned, with the differently colored materials M1, M2 being applied to those sides of the inner wall of the galvanic mold 3 which are separated by the separating element 5 in a uniformly thin layer, for example having a thickness of approximately 1 mm.

After this operation, the separating element 5 is removed, with the aim that, during the sintering process, the two differently colored materials M1, M2 blend in a narrow region at the separation point T thereof, and give rise to a “mixed strip” having a maximum width of 0.5 mm, as shown in FIG. 4. A molded skin 2 produced in this way with a thin “mixed strip” of both materials M1, M2 at the separation point T thereof is used in particular in the case of molded parts or components having a color separation which cannot be seen, because it is completely covered.

In other words: the galvanic mold 3 has an exact contour adapted to the molded part to be formed.

To produce the molded skin 2, the galvanic mold 3 is heated to approximately 200° C. and the contour and/or surface structure thereof is determined by scanning.

With reference to the determined contour and/or surface structure and, if appropriate, the positions of the vat 4 and galvanic mold 3, the vat 4 and the galvanic mold 3 are positioned, centered and then fixed, e.g. locked, in relation to one another. In this case, with reference to the recorded data relating to the contour and/or surface structure, the separating element 5 is adjustable along the arrows P1 and/or P2, for example pneumatically or mechanically, in its end position, where it is mounted in particular in a resilient manner.

The vat 4 is moreover sealed off on the outside and inside.

In the basic position of the vat 4, the separating element 5 is withdrawn or retracted, for example by means of a short-stroke cylinder.

After the vat 4 and the separating element 5 have been positioned, and when the vat 4 is locked to the galvanic mold 3, the separating element 5 is pressed against the inner wall of the galvanic mold 3, for example by means of spring force. As a result of this, no compressed air supply is required at the vat 4.

Then, the apparatus 1 is rotated and the materials M1, M2 are introduced or applied into and therefore to the various sides of the inner wall of the hot galvanic mold 3 in a manner separated by means of the separating element 5, and the seal or molded skin 2 is cast and sintered as solid material similar to mask technology. In this case, the galvanic mold 3 can be heated up to 230° C.

After rotation and after the materials M1, M2 have been introduced and after curing, the separating element 5 is removed, e.g. pulled out, and the two applied materials M1, M2 blend with one another during the sintering or curing phase.

For this purpose, the vat 4 is unlocked and uncoupled from the galvanic mold 3. To prevent the material M1, M2 which has not gelled from falling into the vat 4, suitable means are provided.

For a uniform wall thickness and coalescence of the materials M1, M2 at the separation point thereof, the molded skin 2 can optionally be provided in this region of the separation point with further material by in-mold lamination, in particular PVC powder or a liquid plastisol.

The galvanic mold 3 is moved into a defined sintering position.

The molded skin 2 is then cooled to a removal temperature, removed and therefore removed from the mold. Then, the molded skin 2 is tested for gloss, thickness, separation and other error patterns and the vat 4 having an integrated separating element 5 is cleaned.

FIGS. 5 to 10 schematically show an alternative embodiment of an apparatus 1′ having a galvanic mold 3′ and having a vat 4′ having two separating elements 5′, 5″. The two separating elements 5′, 5″ serve for separating the two materials M1, M2 as they are being introduced into the galvanic mold 3. In addition, the vat 4′ has a separating wall 7 for separating the materials M1, M2 in the vat 4′.

The separating elements 5′, 5″ are adjustable, in particular displaceable, movable, retractable or extendable, along the arrows P1 and/or P2.

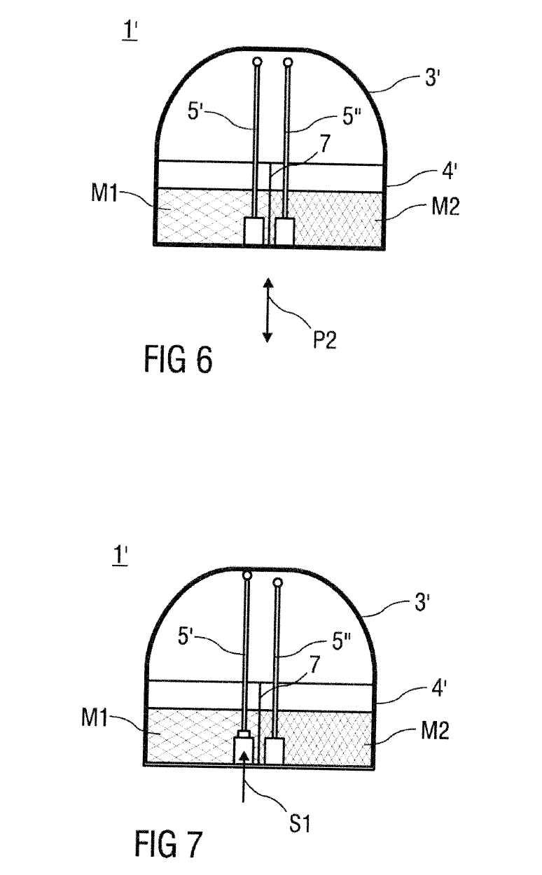

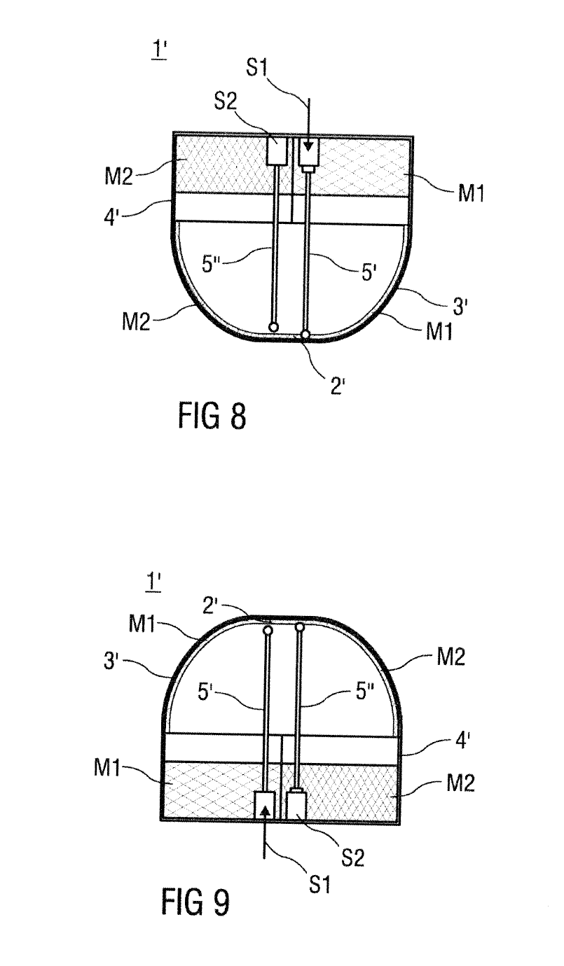

FIG. 5 shows the adjustment along the arrow P1. FIG. 6 shows the adjustment along the arrow P2. FIG. 7 shows how the separating element 5′ is moved into a closed or separating position by means of a slide Si, with the separating element 5″ being in an open position, such that the materials M1, M2 are appropriately separated as they are being introduced into the galvanic mold 3, as shown in FIG. 8.

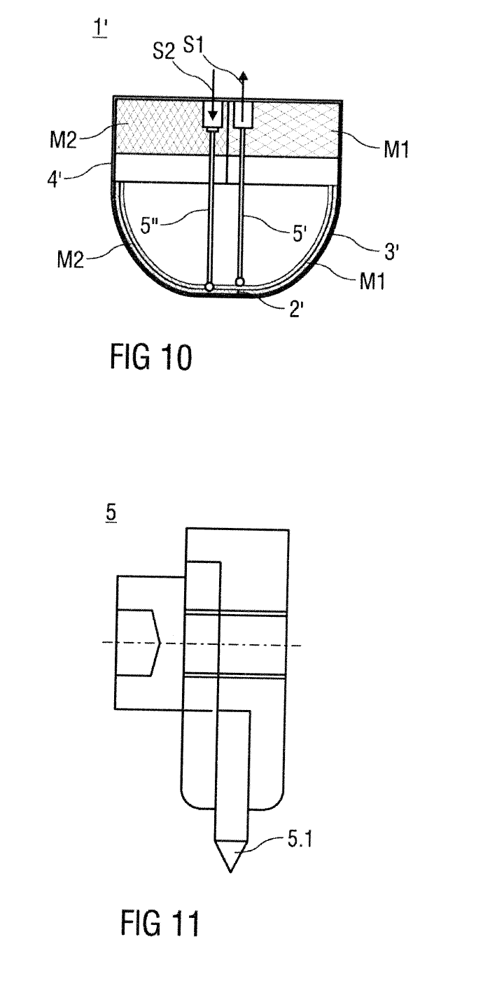

FIG. 8 shows the apparatus 1′ with the slide S1 closed and with the slide S2 open and after the first rotation of the apparatus 1′, as a result of which a two-part molded skin 2′ in the mm range, e.g. of 0.6 mm, is formed. FIG. 9 shows a change of slide, i.e. slide S1 is opened and slide S2 is closed, as shown in FIG. 10. After a second rotation of the apparatus 1′, a further layer is applied to the molded skin 2′ in a thickness of, for example, 1.2 mm. To improve the transition or separation point of the two materials M1, M2 of the molded skin 2′, a plurality of slide changes and rotations with a subsequent sintering and cooling phase can be carried out.

FIGS. 11 to 14 schematically show in detail various exemplary embodiments for a separating element 5 (5′ or 5″) with the conical end 5.1. In the exemplary embodiment shown in FIG. 11, the end 5.1 is integrated, in particular clamped, into the separating element 5. Alternatively, these can be formed in one piece as a component. The end 5.1 serves as a seal with respect to the inner wall of the galvanic mold 3 and therefore as a separation of the materials M1, M2 to be applied to the inner wall, and is preferably formed from a sealing material, in particular from silicone.

As shown in FIGS. 12 to 14, the end 5.1, also called a tip or seal, can have various cross-sectional shapes, for example a pointed shape, a round shape or a rectangular shape.

FIGS. 15 to 19 schematically show various embodiments for a separating groove 8 integrated in the galvanic mold 3 and the end 5.1 of the separating element 5 of the vat 4 for forming a defined separation point for various materials M1, M2 of the molded skin 2.

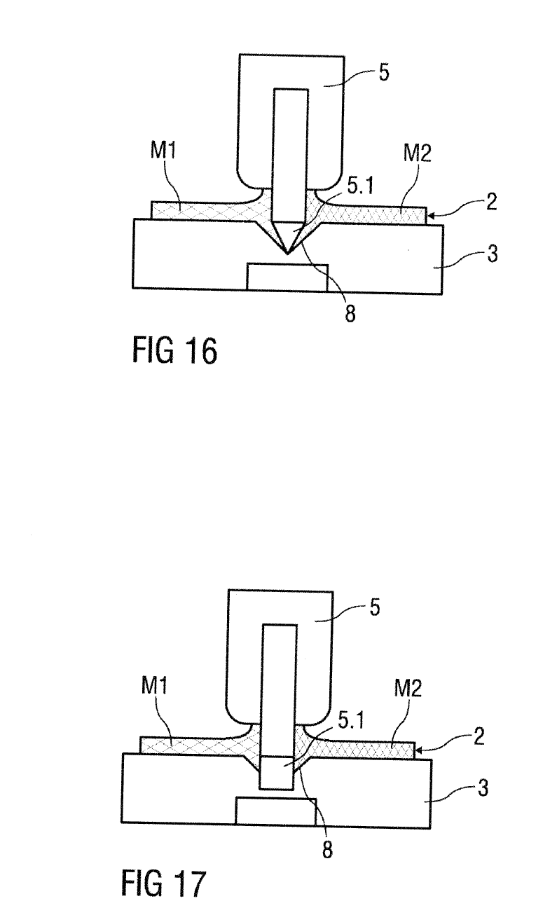

Similarly to the end 5.1, the separating groove 8 can have various cross-sectional shapes, for example an acute-angled shape, a round shape, a polygonal shape or a wide-angled shape. The separating groove 8 preferably has a wider cross-sectional shape than the end 5.1 of the separating element 5. By way of example, the separating groove 8 has a flat V shape and the end 5.1 has a steep V shape (see FIGS. 16 and 19).

Ideally, the separating groove 8 (also called a color separating groove) is introduced into the galvanic mold 3 at a 90° angle to the axis of rotation, as a result of which it is possible to achieve a reduced tendency for the colors to mix when they are rotated alongside one another.

FIG. 20 schematically shows an exemplary embodiment for a position of a covered color separation for a molded skin 2.

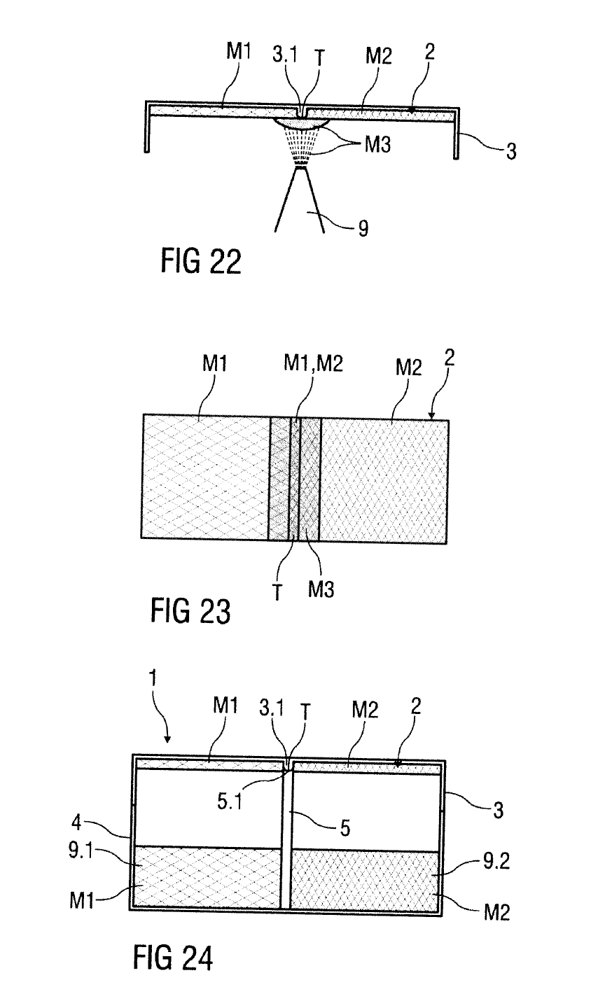

FIGS. 21 to 22 schematically show an exemplary embodiment for the course of the production of a two-colored molded skin 2 having a differently colored separation point T. In this case, similarly to the process described above, two different materials M1 and M2 are applied to an inner wall of a galvanic mold 3 separated from one another by means of a separating element 5. The separating element 5 is arranged in a vat 4 perpendicular to the vat floor in such a manner that two chambers 9.1, 9.2 are formed, in each of which one of the materials M1, M2 is present separated from the other material.

In addition, the separating element 5 protrudes beyond the vat 4 in such a manner that, given a mutual arrangement of the vat 4 and the galvanic mold 3 during the casting process, that end 5.1 of the separating element 5 which points in the direction of the galvanic mold 3 is pressed against a formation 3.1 in the galvanic mold 3. As a result of this, the materials M1, M2 which are separated in the vat 4 by means of the separating element 5 are likewise separated from one another as they are being applied to the inner wall, such that a molded skin 2 made of two different, in particular differently colored, materials M1, M2 is formed.

The formation 3.1 in the galvanic mold 3 can be embodied, as shown, as an integrated elevation, in particular a sealing or separating seam, in order to support the separation of the materials M1, M2 as they are being applied to the galvanic mold 3. In one possible embodiment, the shape of the end 5.1 of the separating element 5 corresponds to the contour or shape of the formation 3.1. Alternatively, the formation 3.1 can be configured as a groove, like the separating groove 8 explained above.

If the vat 4 and the galvanic mold 3 are closed, the separating element 5 is arranged perpendicularly to the axis of rotation of the apparatus 1. During the application of the materials M1, M2 to the inner wall of the galvanic mold 3, the apparatus 1 is rotated about the axis of rotation.

The galvanic mold 3 can be preheated and/or continuously heated in order, inter alia, to optimize the curing process.

Then, the vat 4 is moved away from the inner wall of the galvanic mold 3 together with the separating element 5, or the separating element 5 is moved away therefrom separately. Here, the separating element 5 can be an integral part of the vat 4, in this exemplary embodiment the vat 4 being movable, in particular adjustable in height and/or lengthwise, together with the separating element 5 relative to the galvanic mold 3. As an alternative or in addition, the separating element 5 can be formed separately and can be arranged movably, in particular adjustable in height and/or lengthwise, in the vat 4.

To join the two materials M1, M2 in the region of the separation point T, a further material M3 is then sprayed on. For this purpose, the vat 4 is moved entirely away from the galvanic mold 3 together with the separating element 5. In the region of the separation point T, the at least partially cured molded skin 2 is back-sprayed with a further material M3 or provided with a further material M3 by in-mold lamination, e.g. a PVC powder or a liquid plastisol. For this purpose, a spraying unit 9 can be arranged appropriately with respect to the separation point T.

The further material M3 can have a different color to the materials M1, M2 in order, for example, to mark the separating line or separation point T.

Then, the galvanic mold 3 is moved into a defined sintering position and the molded skin 2 is cooled to a removal temperature and therefore removed from the mold.

FIG. 23 shows the cooled molded skin 2, which has been removed from the mold and is formed from the two materials M1, M2, which have blended with one another at the separation point T and are provided with a further material M3 by in-mold lamination at said point.

FIGS. 24 to 27 schematically show an exemplary embodiment for the course of the production of a two-colored molded skin 2 having materials M1, M2 which have blended at the separation point T without in-mold lamination.

In a manner similar to that described above, the materials M1, M2 are held in the vat 4 separately by means of the separating element 5 and introduced into the galvanic mold 3 separated from one another.

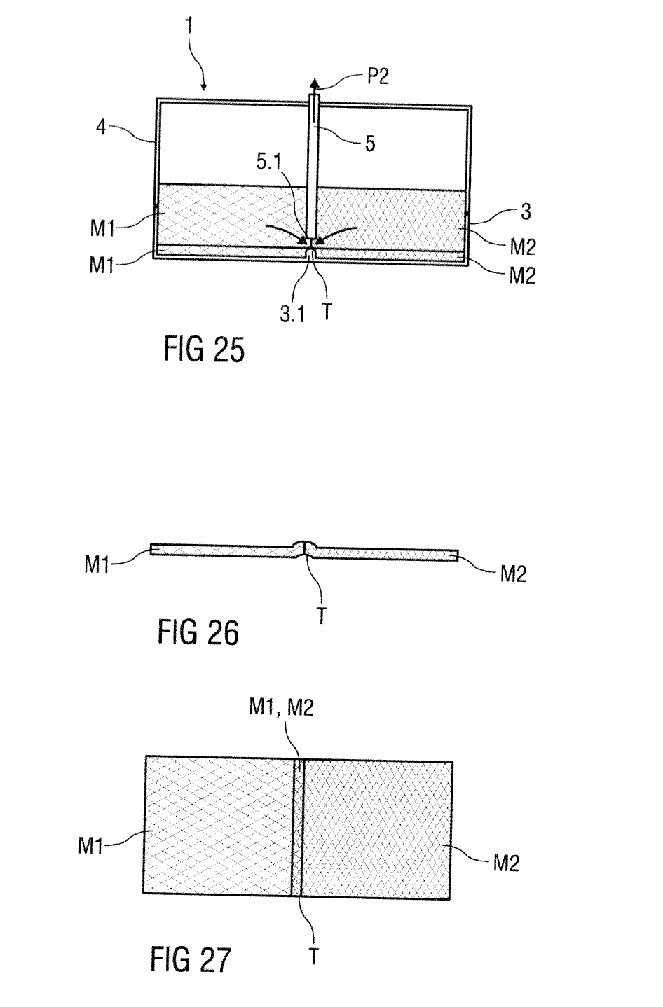

After the application and partial curing or gelling of the materials M1, M2, the vat 4 and the galvanic mold 3 are arranged, in particular rotated, in relation to one another in such a manner that the galvanic mold 3 is positioned at the bottom, as shown in FIG. 25. Then, at least the separating element 5 is moved away from the inner wall of the galvanic mold 3, in particular raised by a few millimeters. The two materials M1, M2 blend together in this region of the separation point T and gel and cure. As an alternative, the vat 4 can be raised together with the separating element 5.

FIGS. 26 and 27 show the resultant molded skin 2 with materials M1, M2 which have blended in the region of the separation point T.

### List of Reference Signs

1, 1′ Apparatus
2, 2′ Molded skin
3, 3′ Galvanic mold
3.1 Formation
4, 4′ Vat
5, 5′, 5″ Separating element
5.1 End of the separating element
6 Cooling device
7 Separating wall of the vat
8 Separating groove of the galvanic mold
9 Spraying unit
9.1, 9.2 Chambers
M1, M2, M3 Materials
P1, P2 Arrows
S1, S2 Slides
T Separation point

1. A process for producing two-colored or multi-colored molded skins comprises:
positioning a vat, in which at least two different materials can be arranged separated from one another, and a galvanic mold forming a molded part or component relative to one another;
introducing and positioning a separating element, which separates the materials and protrudes beyond the vat, in the galvanic mold; and
subsequently introducing the materials into the galvanic mold in at least one layer separated from one another by the separating element.

2. The process as claimed in claim 1, wherein at least one of the separating element and the vat is adjusted in at least one latitude.

3. The process as claimed in claim 1, wherein, in at least one of the positioned and fixed state of the vat and galvanic mold, the separating element is pressed against an inner wall of the galvanic mold with a predefined force.

4. The process as claimed in claim 1, wherein the separating element is removed from the galvanic mold after the materials have been introduced.

5. The process as claimed in claim 1, wherein the galvanic mold is rotated during the introduction of the materials.

6. The process as claimed in claim 1, wherein the materials are deposited on an inner wall of the galvanic mold in such a manner that a multi-colored layer corresponding to the number of materials forms.

7. The process as claimed in claim 6, wherein, after the materials have been deposited on the inner wall of the galvanic mold in the form of a multi-colored layer, the separating element is removed at least partially or entirely from the layer in such a manner that a defined separation point of the materials is formed.

8. The process as claimed in claim 7, wherein a further material is applied in the region of the separation point of the materials.

9. The process as claimed in claim 1, wherein the galvanic mold is heated.

10. The process as claimed in claim 1, wherein the separating element is cooled.

11. An apparatus for producing two-colored or multi-colored molded skins, comprising:
a vat, in which at least two different materials can be arranged separated from one another;
a galvanic mold for forming a molded part or component; and
a separating element, which separates the materials, configured to be arranged in the vat,
wherein the vat and the galvanic mold can be positioned relative to one another
wherein the separating element can be introduced into the galvanic mold protruding beyond the vat, and then the materials can be introduced into the galvanic mold (3, 3′) in at least one layer separated from one another by the separating element (5, to 5″).

12. The apparatus as claimed in claim 11, wherein the separating element is formed as a sword.

13. The apparatus as claimed in claim 11, wherein a plurality of separating elements are arranged in the vat.

14. The apparatus as claimed in claim 11, wherein the separating element is coated or provided at least partially with a sealing material or has a varying thickness.

15. The apparatus as claimed in claim 11, wherein the galvanic mold is provided with a separating groove made in the inner wall.
